(19) United States
(12) Patent Application Publication
(10) Pub. No.: US 2013/0147189 A1
(43) Pub. Date: Jun. 13, 2013

(54) FACE SEAL CONDUIT FITTING INCLUDING SUBASSEMBLY

(71) Applicants: ANDREW HORSFALL, CUYAHOGA FALLS, OH (US); VINCENT TRAINA, CONCORD TOWNSHIP, OH (US); ANTHONY CHIHILL, RICHFIELD, OH (US); DON LEVENGOOD, CHAGRIN FALLS, OH (US); RUSSELL DIEMER, KIRTLAND, OH (US); JASON LISY, MENTOR, OH (US)

(72) Inventors: ANDREW HORSFALL, CUYAHOGA FALLS, OH (US); VINCENT TRAINA, CONCORD TOWNSHIP, OH (US); ANTHONY CHIHILL, RICHFIELD, OH (US); DON LEVENGOOD, CHAGRIN FALLS, OH (US); RUSSELL DIEMER, KIRTLAND, OH (US); JASON LISY, MENTOR, OH (US)

(73) Assignee: TYLOK INTERNATIONAL, INC., EUCLID, OH (US)

(21) Appl. No.: 13/659,681

(22) Filed: Oct. 24, 2012

Related U.S. Application Data
(63) Continuation-in-part of application No. 13/287,965, filed on Nov. 2, 2011.

(51) Int. Cl. F16L 19/04; F16L 19/065

(52) U.S. Cl. CPC F16L 19/046; F16L 19/065
USPC 285/353; 285/384

(57) ABSTRACT

A fitting includes a body and a subassembly to connect to the body. The subassembly includes a gland, a nut and one or more collets captured between gland and nut. An O-ring is seated in a recess in one of the body and the gland. The gland can receive a conduit and the nut serves both to compress the collets around the conduit and to press the gland against the body. The nut may be retracted to a position where the subassembly may be moved transverse to the axis of the conduit, gland and nut without first retracting the gland and conduit axially.

### RELATED APPLICATIONS

This application is a continuation in part of application Ser. No. 13/287,965, filed Nov. 2, 2011, assigned to the assignee of this application.

### TECHNICAL FIELD

The present disclosure relates fittings for conduits such as tubes and pipes, and in particular to a flare-less or grip-type fitting with a face seal to join a conduit to another component.

### BACKGROUND

Flare-less and grip-type fittings use one or two collets (or ferrules) and a nut that cooperate with a body. A leak-proof seal is obtained as the collets are tightened onto a conduit through the axial thrust provided by the nut. The front collet provides a leak-proof seal when the nut and collets are drawn up a specified number of turns. The rear collet grips the conduit to prevent pull off. Other similar fittings use a single collet, and work in much the same way.

The body of a fitting is adapted not only to accept the conduit and nut from one end, but to be connected to another component at its opposite end. For this reason the body may have, for example, external or internal threads to join it to the other component, or a nipple for connecting it to a hose or a other conduit, or a fitting for a flare union.

In order to assemble a flare-less or grip-type fitting, it is necessary to insert an end portion of the conduit through the nut, through the collets, and into the body prior to tightening the nut. Once the collets are tightened onto the conduit, they cannot be removed easily, and disassembly of the fitting requires the conduit to be pulled out axially from the fitting body. This fact can make the use of flare-less and grip-type fittings difficult or impossible in some applications. For example, where a conduit must bend sharply, it may be impossible to install the conduit into mutually perpendicular fittings without bending and damaging the conduit.

### SUMMARY

The present application discloses a fitting for connecting a conduit to another component. The fitting combines a collet-seal with the conduit and a face seal for connecting to the other component. The fitting comprises includes subassembly that connects to a body, the body in turn is a body adapted to connect to the other component, or the body may be part of the other component. The body has a passage therethrough through it for carrying a fluid, and the passage terminates at a generally flat first face transverse to the passage. The fitting also subassembly comprises a gland having a passage therethrough through it for carrying a fluid, and the passage through the gland terminates at a generally flat second face transverse to the passage. The first and second faces are proportioned to be positioned in sealing engagement and with with each other so that the passage through the gland is in fluid communication with the passage through the body. The gland has an internal passage for receiving an end portion of the conduit. The fitting subassembly further comprises one or more collets (a collet assembly) proportioned to surround the conduit and adapted to be squeezed into sealing engagement with the outside of the conduit. A nut surrounds surrounding the gland is also part of and the subassembly. The nut is adapted to engage the body, to force the first face (on the body) and second face (on the gland) into sealing engagement with each other, and to force the collet assembly into sealing engagement with the conduit and the internal passage in the gland. The nut is movable between advanced and retracted positions. When the nut is in the advanced position, it engages the body, transmitting an axially compressive force to the first collet collet assembly and pressing the forward end face of the gland against the rear end face of the body. When the nut is in the retracted position, it has its forward end face is no farther forward than the plane of the forward end face of the gland, allowing the fitting subassembly to be moved laterally of the body without axial movement of the conduit away from the body. The collet assembly and the gland may be captured at least partially within the nut.

### BRIEF DESCRIPTION OF THE DRAWINGS

While the specification concludes with claims particularly pointing out and distinctly claiming the present invention, it is believed that the same will be better understood from the following description taken in conjunction with the accompanying drawings in which:

FIG. 1 shows a fitting having features disclosed in this application including I'm not a nut engaging a body to seal a gland to the body;

FIG. 2 is a cross sectional view of the fitting illustrated in FIG. 1 but showing the nut nut backed off the body so the body and gland may be separated;

FIG. 3 is an exploded view of the fitting of FIG. 1;

FIG. 4 is a cross-sectional view of the fitting of FIG. 1 before it has been made up;

FIG. 5 is a cross-sectional view of the fitting of FIG. 4 after it has been made up;

FIG. 6 is a cross-sectional view of the a fitting similar to that shown in FIGS. 1-5 but having a single collet.

FIG. 7 is a cross-sectional view of the a fitting similar to that shown in FIGS. 1-5 but having a different collet;

FIG. 8 is a cross-sectional view of a fitting similar to that shown in FIG. 4 but having an alternate structure for capturing a collet assembly and a gland within a nut; and

FIG. 9 is a cross-sectional view of a portion of a fitting similar to that of FIG. 4 but having a second alternate structure for capturing a collet assembly and a gland within a nut;

FIG. 10 is a cross-sectional view of a fitting similar to that shown in FIGS. 1-5 but having an O-ring in a different location, i.e., independent of the body; and

FIG. 11 is a cross sectional view of a fitting with a pair of O-rings that retain the gland and collets within the nut.

### DETAILED DESCRIPTION

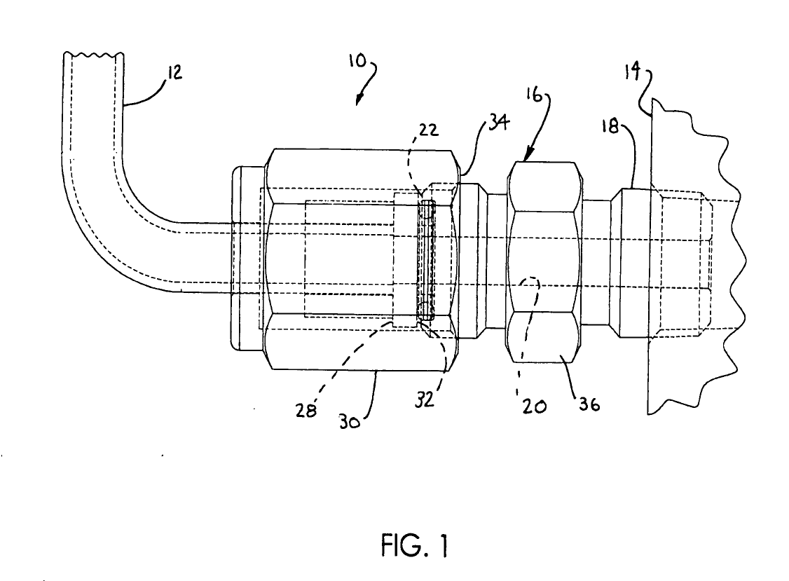

The fitting 10 shown in FIG. 1 is adapted to connect a conduit 12 to another component 14. To facilitate the specification which follows, the terms “forward” and “rearward” or “front” and “rear” are used, but they are not intended to be limiting in any way. As viewed in FIG. 1, the rear of any piece is to the left, while the front is to the right, but this convention is intended only to make this description and the claims that follow easier to read and understand.

The conduit 12 may be what is termed the a “tube”, a “pipe”, or any other type of device for carrying fluid under pressure. The fluid may be a liquid or gas, a combination, or even a slurry. The fluid may be at a higher or lower pressure than ambient.

The component 14 can be any device or object to or from which fluid from the conduit 12 is to flow. As illustrated in FIG. 1, the fitting 10 includes a body 16 with a threaded end portion 18 which can be screwed into the component 14. However, the body 16 may be connected to the component 14 by other means, or many be integrally formed with it. The body 16, whether integral with the component 14 or a separate piece, may be manufactured and/or marketed by the same manufacturer or marketer as makes the remaining parts of the fitting or by a different manufacturer or marketer.

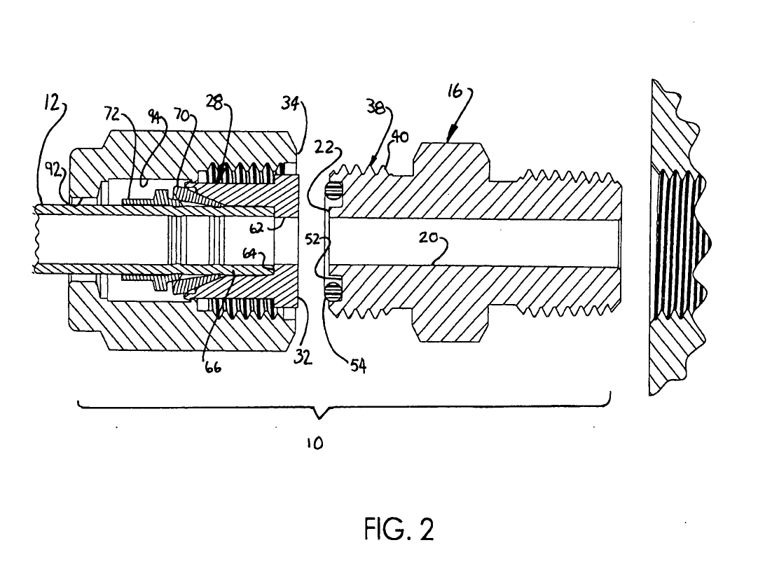

The fitting 10 includes the body 16, a gland 28, and a nut 30. The body 16 includes a central passage 20 and a rear end face 22 generally normal to the axis of passage 20. The gland 28 includes a front end face 32. The two inter end faces 22 and 32 are proportioned to seat against each other. When the nut 30 is screwed onto the body 16 (moving to the right in FIG. 1), the front end face 32 of the gland 28 is pulled tight against the rear end face 22 of body 16 to form a fluid tight seal between the gland 28 and the body 16. When the nut 30 is screwed off the body 16, the nut is free to slide along the conduit 12 (to the left or rear in FIG. 1.) The Accordingly, the nut 10 can be retracted to the left as from the position shown in FIG. 1 by by unscrewing it and then sliding it along the conduit 12 so that it's front end face 34 is to the rear of end face 22 of the body 16 as shown in FIG. 2, and in. In that condition, a the conduit 12, nut 30, and gland 28 can slide laterally with respect to the body 16 and no axial movement of the conduit 12 or gland 28 is required. As a consequence of being able to retract the nut 30 until it clears the body 16, the fitting 10 can be used in tight quarters. Axial movement of the conduit 12 is not required to separate the conduit from the body 16.

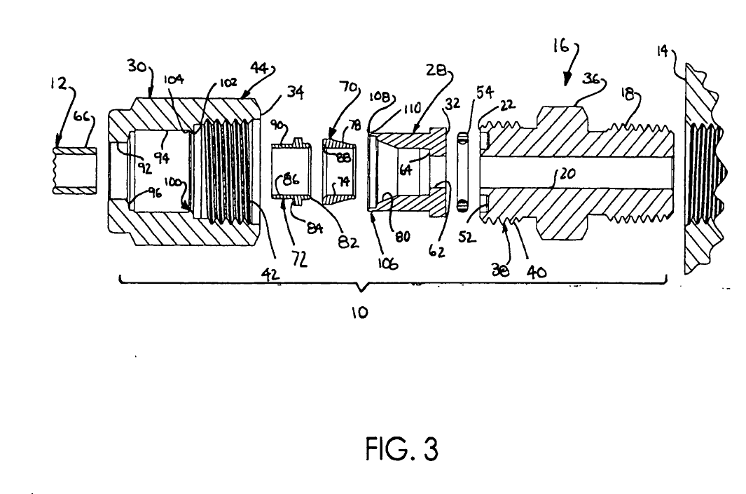

FIG. 3 shows the fitting 10 in an exploded, cross-section view. The body 16 includes the central passage 20. The passage 20 carries fluid from between the gland 28 to and the component 14. The body 16 also includes an external hex surface 36 which facilitates screwing the threaded end portion 18 of the body into the component 14. In some applications the hex surface 36 may not be required, for example, where the body 16 is integrally formed with the component 14 or welded to it otherwise securely connected to it.

The rear end portion 38 of the body 16 includes threads 40. The threads 40 engage the threads 42 in the front end portion 44 of the nut 30. The threads 42 40 and 44 42 cooperate to pull the nut 30 over the body 16. The threads 42 40 and 44 42 may be replaced by any equivalent structure such as a pin and cam arrangement like those found in bayonet fittings or any other mechanism that can draw the nut 30 toward the body 16 with a suitable force to seal the faces 22 and 32 against each other.

The body 16 terminates at a rear end face 22. The rear end face 22 is generally flat and transverse to the axis of passage 20. Generally, the rear end face 22 may be normal to the axis of passage 2220. An annular recess 52 is formed in the end face 22 to hold a resilient O-ring seal 54 which helps seal the gland 28 to the body 16.

The gland 28 has a forward end face 32 and a central passage 62. The forward end face 32 is generally flat and transverse to the axis of passage 62. Generally, the forward end face 32 may be normal to the axis of the passage 62. When the fitting 10 is made up by turning the nut 30 onto the body 16, the forward end face 32 of the gland 28 presses against the rear end face 22 of the body 16 and compresses the O-ring 54 to make a fluid-tight seal between the gland and the body. The O-ring seal 54 can be omitted altogether and/or replaced with any suitable gasket or sealant to facilitate creating a fluid tight seal between the faces 22 and 32 when the fitting 10 is made up.

There are numerous types of face-to-face connections which may be used. The connection between the gland 28 in and the body 16 may be of the type described in SAE 1453, but many others are known and may be required for particular applications. In some the forward end face 32 of the gland 28 and the rear end face 22 of the body 16 may be provided with interlocking ridges and grooves rather than being completely flat. These ridges and grooves may be circumferential to provide a seal, or radial to provide for a particular angular alignment. In addition, as noted above, the rear end face 22 of the body 16 and the forward end face 32 of the gland 28 may be inclined with respect to the axis of the central passage 62 through the gland 28 and the central passage 20 through the body 16.

An annular face 64 in passage 62 enlarges the diameter of the passage 62 so that it can accommodate an end portion 66 of the conduit 12. The annular face 64 limits forward movement of the conduit 12 as it is inserted into the gland 28.

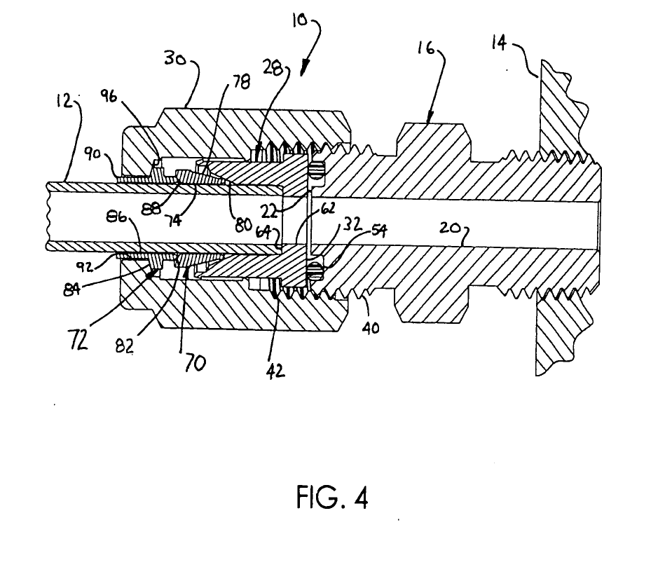

The fitting 10 may use two collets, front collet 70 and rear collet 72, to seal against the conduit 12 and to hold the conduit in place. The front collet 70 includes a cylindrical inside surface 74 that initially slides over the outside of the conduit 12, as shown in FIG. 4. The front collet 70 also includes an exterior tapered surface 78.

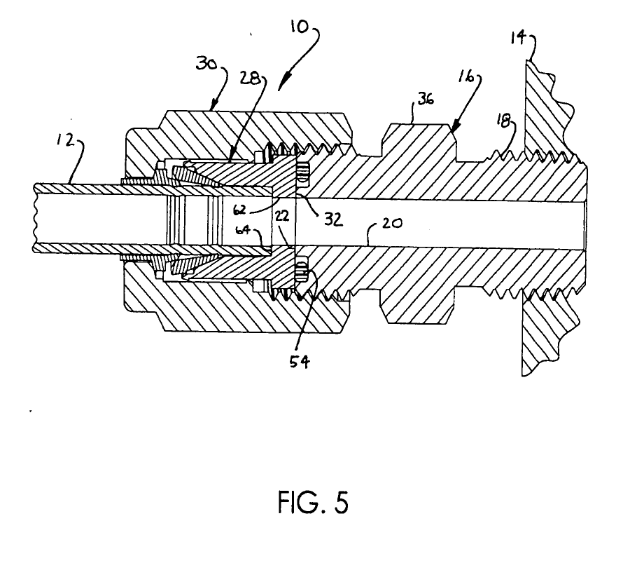

The gland 28 (FIG. 3) includes a an internal tapered surface 80 which cooperates with the tapered surface 78 of the front collet 70. The tapered surface 80 is conical, opening outward as it extends rearward. When the front collet 70 is forced forward, it burnishes and then squeezes the conduit 12 forming a fluid tight seal as it is driven to the position shown in FIGS. 2 and 5.

The rear collet 72 (FIG. 3) includes a tapered front end portion 82, an annular shoulder 84, and a cylindrical inside surface 86. The inside surface 86 is proportioned to slide over the end portion 66 of the conduit 12 before the fitting 10 is made up for the first time, as shown in FIG. 4. During initial makeup of the fitting, the tapered front portion 82 of the rear collet 72 engages with a tapered entry passage 88 of the front collet 70 and is driven radially inward and bites into the conduit 12, preventing the conduit from being withdrawn. FIGS. 2 and 5 show the fitting 10 after it has been made up the first time.

The rear collet 72 may also include a tubular extension 90 which extends rearward from the annular shoulder 84. See FIG. 3. A The tubular extension 90 has an outside diameter proportioned to fit through an a rear opening 92 in the nut 30. The tubular extension 90 serves to keep the rear collet centered and also to protect the conduit 12 from abrasion as the nut 30 is rotated.

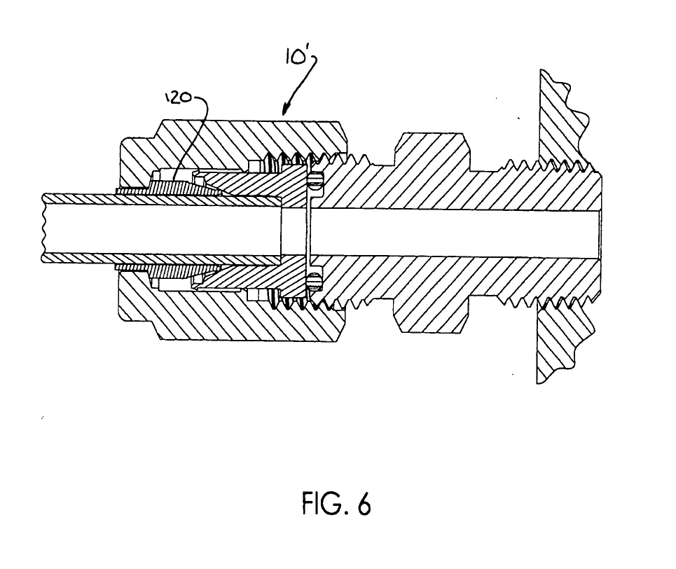

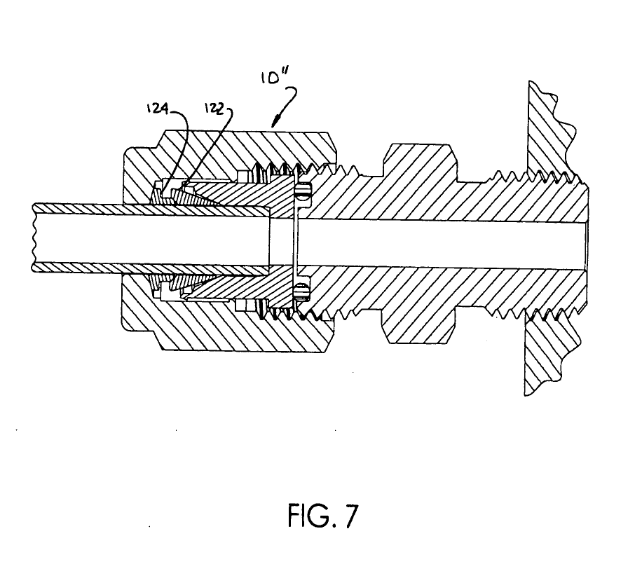

While the fitting 10 is described as using a front and rear collets 70 and 72, it is possible to use a single collet 120 in place of the front and rear collets, and single collet, flare-less fittings are well known. Such a fitting 10′ is shown in FIG. 6. Other style collets may also be used, such as the collets 122 and 124 used in fitting 10″ shown in FIG. 7. The fittings 10′ and 10″ are identical to the fitting 10, except for the collets used in and changes to the nut to accommodate the collets. The fitting 10″ need not be described further.

As shown in FIG. 3, the nut 30 includes a central passage 94 forward of and larger in diameter than the rear opening 92. The rear opening 92 and the central passage 94 are connected by an inclined surface 96 which is parallel to the annular shoulder 84 of the rear collet and proportioned to engage the annular shoulder 84 of the rear collet as the nut 30 is driven forward. The central passage 94 forms a cavity in which the front and rear collets 70 and 72 are located when the fitting 10 is assembled. The forward portion of the central passage 94 includes threads 42 which, as discussed above, cooperate with the threads 40 on the body 16.

Before assembly, the gland 28, nut 32, and front and rear collets 70 and 72 are free of each other. Loose collets and a gland may be hard to manipulate and install correctly. Therefore the gland 28 and nut 30 are designed to retain the collets 70 and 72 prior to initial makeup of the fitting 10. To this end, the central passage 94 in the nut 30 includes an annular ridge 100. The annular ridge 100 includes the tapered surface 102 which faces the front of the nut 30 and a stop surface 104 which faces to the rear. The annular ridge 100 in the nut 30 cooperates with a similar annular ridge 106 located at the rear end of the gland 28. The ridge 106 in on the gland 28 includes a tapered surface 108 which faces rearward and a stop surface 110 which is more nearly perpendicular to the axis of the gland 28 and faces forward. The ridges 100 and 106 act as a one-way catch, allowing assembly but not disassembly of the nut 30 onto the gland 28 and capturing the collets 70 and 72 in position between the gland and nut prior to any assembly with the body 16. The gland 28, nut 30, and collets 70 and 72 (or collets) are termed herein a “fitting subassembly”.

To assemble When assembling the nut 30, collets 70 and 72, and gland 28, first the front collet 70 is first placed in the gland 28 with the tapered surface 78 of the front collet 70 touching the tapered surface 80 of the gland. Next, the rear collet 72 is positioned with its forward tapered surface 82 in contact with the tapered surface 88 at the rear of the front collet 70. Thereafter the nut 30 is placed over the two collets 70, 72 and the gland 28. As the ridge 106 at the rear of the gland passes the rear end of the threads 42, the tapered surface 108 of the ridge 106 engages the tapered surface 102 of the ridge 100. A slight force is required to squeeze the ridge 106 past the ridge 100, facilitated by the two tapered surfaces 108 and 102 and the relatively thin section 112 at the rear of the gland 28. As the gland 28 is forced further into the central passage 94 in the nut 30, the ridge 106 expands radially outward, and thereafter the stop surface 110 and the stop surface 104 on the gland 28 and nut 30, respectively, prevent the gland 28 from being removed. Thus the collets 70 and 72 and the gland 28 are captured within the nut 30, and it is therefore impossible to lose unlikely that the two collets 70 and 72 will get lost unless the gland 28 is forcibly removed, without destructively removing the gland 28. The position of the ridge 106 and the ridge 102 are selected so that the stop surfaces 104 and 110 engage each other as the nut is being moved rearward only after the end face 34 of the nut 30 has moved rearward of the end face 60 of the gland 28, as shown in FIG. 2.

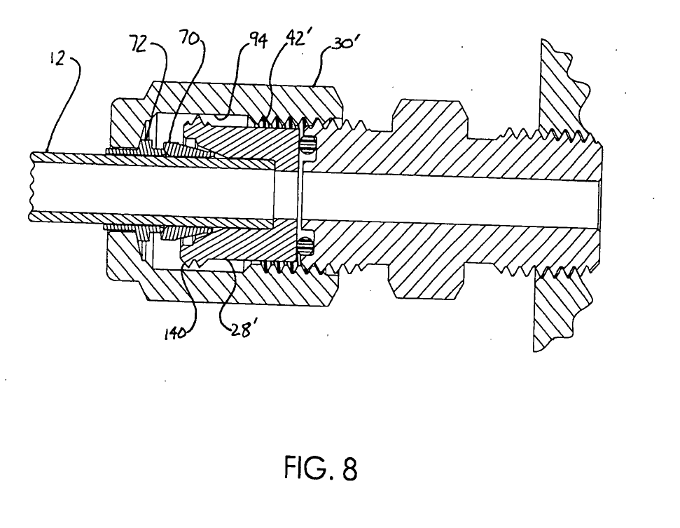

As an alternative to the ridges 100 and 106, a threaded arrangement may be used as shown in FIG. 8. Here the female threads 42′ in the nut 30′ extended extend rearward to join the passage 94. (The ridge 100 in the nut has been eliminated.) On the gland 28′, the ridge 106 has been replaced by male threads 140. The threads at 140 cooperate with the threads 42′. Because the male threads 140 have an outside diameter smaller than the inside diameter of the passage 94 through the nut 30′, once the nut 30′ has been screwed onto the gland 28′ by turning it through the required number of turns, the gland is free to move axially within the nut, and the collets 70 and 72 are captured within.

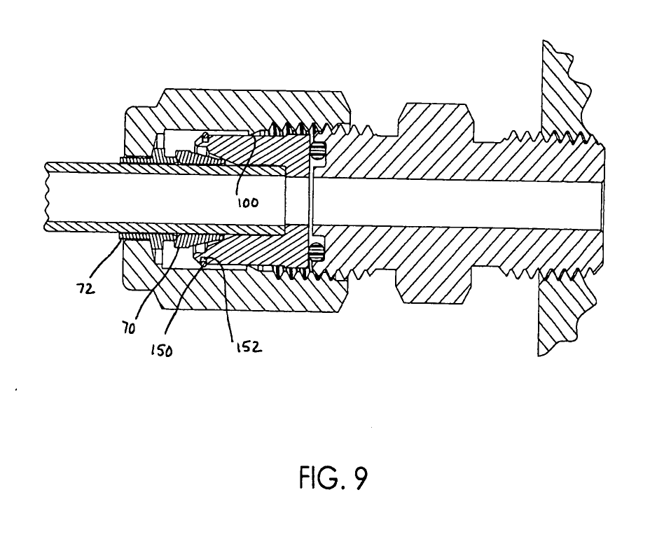

Another alternative to the ridges 100 and 106 is to replace one of them with a spring clip 150 shown in. FIG. 9. For example, the ridge 106 may be replaced with a annular recess 152 proportioned to receive the spring clip 150. When the ridge 100 is pressed past the spring clip 150, it cannot be removed without deforming or destroying the gland 28′, thus assuring guaranteeing that the collets will be retained in place between the nut 30 and gland 28′ prior to initial make up of the fitting 10. In a further variation, the ramp 100 and/or the ramp 106 may shaped to retain the gland but allow disassembly. This can be done, for example, by making the stop face 104 a ramp, symmetrical with the tapered surface 102.

Various techniques may be used to assure that the collets 70 and 72 remain properly aligned prior to insertion of the conduit 12 into the fitting 10 and initial makeup of the fitting on the conduit. One such arrangement is shown in FIG. 4. Here the body 16 has been threaded into the nut 30 until there is contact between the tapered surface 80 of the gland 28, the tapered surface 78 of the front collet 70, between the tapered surface 88 at the rear of the front collet and the tapered surface 82 at the front of the rear collet 72, and between the shoulder 89 84 on the rear collet and the tapered surface 96 in the nut. The contact should does not involve an axial preload which might distort the collets making installation of the conduit 12 difficult.

Other techniques may also be used to hold the collets 70 and 72 in alignment with the passage 92 through the nut 30 and the passage 62 through the gland 28. These techniques include adhesives and/or lubricants to hold the collets 70 and 72 and gland 28 in proper orientation. One product that may be used is wax which may hold the collets 70 and 72 in place. The adhesive and/or lubricant may be applied as a coating or it may be foamed to full fill the entire space between the collets 70 and 72 and the nut 30 except for a passage where the tube 12 will be inserted. As an alternative, the tubular extension 90 of the rear collet 72 may be extended so that even when the gland 28 is in its forward most position, the tubular extension is housed within the rear opening 92 in the nut 30. In this case the tubular extension may be provided with a dimple (not shown) which projects outwardly and contacts the passage 92 through the nut 30. Upon initial makeup of the fitting, the dimple is forced through the passage 92 in the nut, its purpose having been served.

To use the fitting 10, a conduit 12 is inserted into a subassembly consisting of the nut 30, the collets 70 and 72, and the gland 28. The conduit passes through the opening 92 in the nut 30, through the passage 86 through the rear collet 72, through the passage 74 through the front collet 70, and into the gland 28 until the leading end face of the conduit 12 contacts the annular face 64 in the gland. See FIG. 4. The gland 28 is then placed with its front end face against the rear end face 22 of the body 16. The nut 30 is then turned to engage the threads 40, and 42 to pull the nut forward. The inclined surface 96 in the nut forms a shoulder which engages the annular shoulder 84 of the rear collet 72, pushing it forward. The rear collet 72 in turn pushes the front collet 70 forward into the tapered surface 80 at the rear of the gland 28. As the nut 30 moves forward, the collets 70 and 72 slide along and then are compressed around and into the conduit 12, sealing against it. At the same time the front face 32 of the gland 28 is pressed against the rear face 22 of the body 16, compressing the O-ring 54 and effecting a seal between the gland and the body, as shown in FIG. 5. Thus a single nut 30 serves both to drive the collets 70 and 72 into sealing engagement with the conduit 12 and to pull the front face 32 against the rear face 22 of the body 16. It is noteworthy that a single operation, turning the nut 30 while holding the body 16 against rotation, holding the body 16 against rotation while turning the nut 30, serves both to compress the collets 70 and 72 onto the conduit 12 and to seal the gland 28 against the body 16. In addition, the fitting 10 is axially compact, allowing it to be used in some applications where longer fittings or combinations of fittings cannot be used.

When it is necessary to disconnect the conduit 12 from the component 14, the nut 30 may be screwed back and then slid rearward until its end face 34 is rearward of the front face 32 of the gland 28, as shown in FIG. 2. This allows lateral movement of the gland 28 and nut 30 with respect to the body 16 with little or no axial movement of the forward end face 32 of the gland away from the rear end face 22 of body 16.

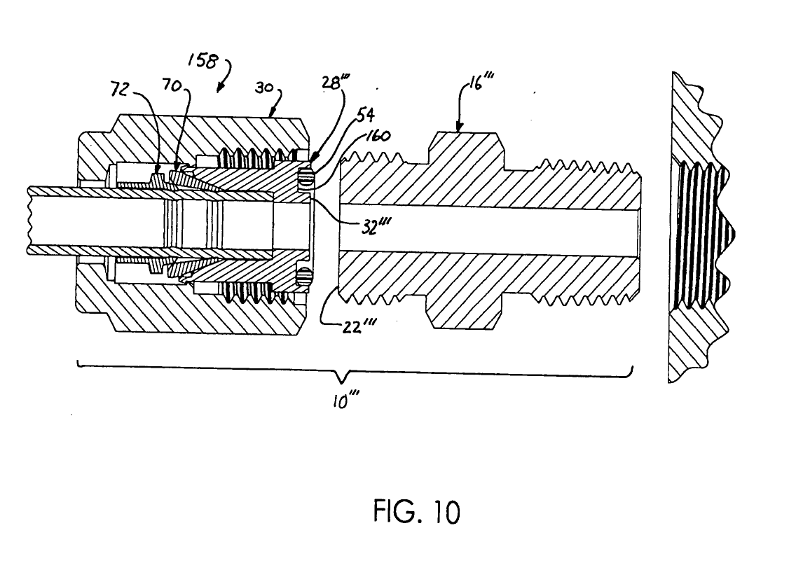

FIG. 10 shows a fitting assembly 10′″ that is in most respects similar to the fitting illustrated in FIGS. 1-5. Reference numerals with a′″ (triple prime) are used to identify parts shown in FIG. 10 that differ from the corresponding parts of the FIGS. 1-5 embodiment. Reference numerals that are unchanged refer to parts that are generally identical in both embodiments.

The fitting assembly 10′″ includes a subassembly 158 comprising gland 28′″, nut 30, and collets 70 and 72. The subassembly 158 cooperates with the body 16′″ to form a fluid-tight seal. The difference between the embodiment shown in FIG. 10 and that illustrated in FIGS. 1-5 lies in the location of the O-ring 54. In the embodiment of FIG. 10, an annular recess 160 is formed in the end face 32′″ of the gland 28′″. The O-ring 54 is received in the recess 160 and is compressed against the rear end face 22′″ of the body 16′″. Unlike the body 16 in the embodiment shown in FIGS. 1-5, the end face 22′″ of the body 16′″ is an annular flat surface so that the O-ring 54 may seat against it.

The operation of the FIG. 10 embodiment is the same as the FIGS. 1-5 embodiment and need not be described further. The FIG. 10 arrangement may be useful, for example, where it is difficult to gain access to the end face 22′″ to replace the O-ring 54, or where other manufacturing considerations make it difficult or undesirable to form a recess in the end face 22′″ of the body 16′″.

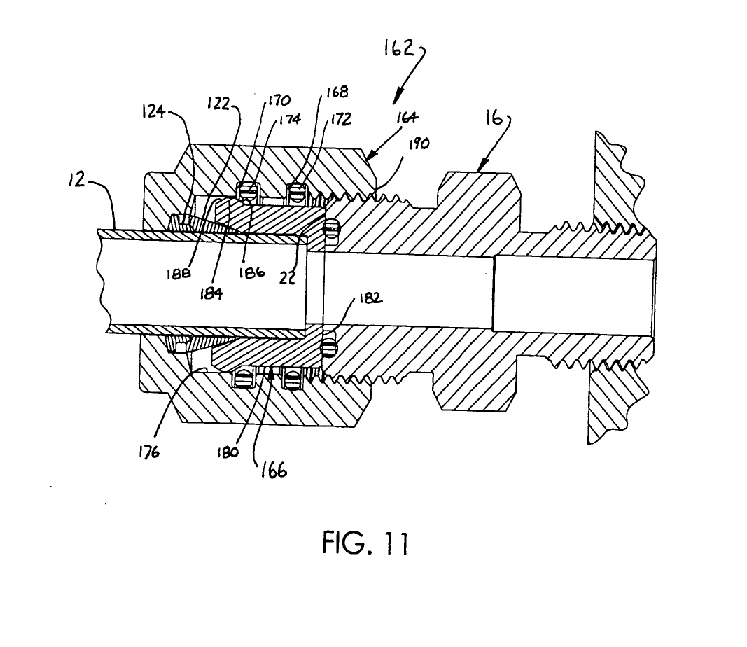

FIG. 11 shows another fitting 162 constructed according to the teachings of this disclosure. Where parts are identical to parts disclosed above in this application, the same reference numerals are used. In the fitting 162 shown in FIG. 11, a nut 164 can be screwed onto the body 16 to squeeze the front and rear collets 122 and 124, respectively, as disclosed above, both to effect a seal between the conduit and the gland 166 and to press the gland against the body 16.

The nut 164 is similar to the nut 10 except that it does not use inter-engaging ribs 100 and 106 to hold the nut on the body 16. Instead, the nut 164 has a pair of annular recesses 168 and 170, each receiving a resilient O-ring, 172 and 174, respectively. The O-rings 170 and 172 project part way into the central passage 176 through the nut 160.

The gland 166 is shaped to cooperate with the O-rings 172 and 174 to retain the collets 122 and 124 within the nut 164 and in alignment with the central passage 176 through the nut prior to the fitting 162 being made up for the first time and to keep the nut from sliding too far to the rear when it is disconnected from the body 16. To these ends the gland 166 has a cylindrical outside wall 180 leading rearward from the forward end face 182. The cylindrical wall 180 has a smaller diameter than the inside diameter of the O-rings 172 and 174. The rear region of the gland 166 includes an annular ridge 184 which cooperates with the O-rings to hold the nut 164 on the gland 166. The ridge 184 has a maximum diameter that is only slightly smaller than the inside diameter of the nut 160, and it is larger than the inside diameter of the O-rings 172 and 174 when they are in their normal or relaxed state.

The annular ridge 184 includes leading and trailing frusto-conical ramps 186 and 188 that cause the gland 166 to expand the O-rings 172 and 174 when the gland is forced past them. The O-rings 172 and 174 may be made of any suitable resilient material, such as conventional elastomeric O-rings, or they may be snap rings made of metal. If metal they may be annular, polygonal or zigzag in shape.

The fitting 162 is shown in its “finger tight” condition, the way it would be sold to a customer. The gland 166 has been pushed past both O-rings 172 and 174 and lightly engages the front and rear collets 122 and 124, respectively, to keep them properly oriented and centered for easy insertion of the conduit 12. When the fitting 162 is made up for the first time, the nut 164 and collets 122 and 124 move forward (to the right in FIG. 11) with respect to the gland 166, effecting a seal with the conduit 12 and body 16. When the nut 164 needs to be separated from the body 16, the nut can be turned off the body, with the leading ramp 186 pressing the O-ring 174 outward so that the nut 164 can move rearward. After the ridge 184 passes the rear O-ring 174, the nut 164 can be retracted until the leading ramp 186 reaches the O-ring 172. At that point, the front face of the nut 164 is clear of the rear face 22 of the body 16, and the subassembly (comprising the nut 164, the collets 122 and 124 and the gland 166) can be moved laterally of the body. If additional clearance is required, the nut can be forced back further with the leading ramp 186 expanding the O-ring 172 as it passes through it.

As with other fittings disclosed above, the location of the O-ring that forms the face seal can be in the body 16 as shown in FIG. 11, or it can be in a recess (not shown) in the forward end face 182 of the gland 166. In addition, with minor modifications different collet styles can also be used. In a further variation, the roles of the ramps and O-rings that keep the gland and nut together can be reverses. In such a case, not shown, a recess could be formed in the rear end portion of the gland 162, and two annular ridges could be formed inside the nut, spaced about as the O-rings 172 and 174 are spaced. The two ridges would function as detents, the rearmost ridge engaging the single O-ring to hold the gland in contact with the two collets before the fitting is made up, and the rear ridge stopping the nut from retracting more than necessary to clear the rear face 22 of the body 16.

While the inventive principles have been illustrated by the description of various embodiments thereof, and while the embodiments have been described in considerable detail, it is not intended to restrict or in any way limit the scope of the appended claims to such detail. Additional advantages and modifications will be readily apparent to those skilled in the art. The invention in its broader aspects is therefore not limited to the specific details, representative apparatus, methods and examples shown and described. Accordingly, departures may be made from such details without departing from the scope or spirit of the general inventive principles.

1. A fitting subassembly adapted to cooperate with an axially extending body having a generally flat rear end face transverse to the axis of the body, the fitting subassembly comprising:
a gland having a central axis and a generally flat forward end face transverse to the axis of the gland and proportioned to seat against the rear end face of the body,
at least a first collet, and
a nut proportioned to surround the first collet and the gland and having a forward end face, the nut being movable forward and rearward between advanced and retracted positions, respectively, the nut in the advanced position engaging the body and transmitting an axially compressive force to the first collet and pressing the forward end face of the gland against the rear end face of the body, and the nut in the retracted position having its forward end face no farther forward than the plane of the forward end face of the gland, and
the gland and the nut having inter-engaging ridges limiting axial movement of the nut with respect to the gland in a rearward direction.

2. The fitting subassembly of claim 1 wherein the body has threads and the nut of the fitting subassembly has corresponding threads, whereby the nut can be screwed onto the body.

3. The fitting subassembly of claim 1 wherein the front end face of the gland includes an annular recess.

4. The fitting subassembly of claim 3 further including a resilient O-ring received in the annular recess.

5. The fitting subassembly of claim 1 wherein the gland includes a central passage proportioned to receive a conduit, and the passage includes a shoulder to limit axial movement of the conduit in the forward direction.

6. The fitting subassembly of claim 5 wherein the gland includes a tapered passage proportioned to receive the first collet.

7. The fitting subassembly of claim 1 further including a second collet, the first collet and the second collet having cooperating tapering services that force a portion of the first collet radially outward and a portion of the second collet radially inward when the second collet is pressed axially against the first collet.

8. A fitting subassembly adapted to cooperate with an axially extending body having a generally flat rear end face transverse to the axis of the body, the fitting subassembly comprising:
a gland having a central axis and a generally flat forward end face transverse to the axis of the gland and proportioned to seat against the rear end face of the body,
at least a first collet, and
a nut proportioned to surround the first collet and the gland and having a forward end face, the nut being movable forward and rearward between advanced and retracted positions, respectively, the nut in the advanced position engaging the body and transmitting an axially compressive force to the first collet and pressing the forward end face of the gland against the rear end face of the body, and the nut in the retracted position having its forward end face no farther forward than the plane of the forward and face of the gland, and
wherein the at least first collet and gland are captured within the nut when the nut is in the retracted position.

9. The fitting subassembly of claim 8 wherein the nut and gland have cooperating stop surfaces to retain the gland within the nut.

10. The fitting subassembly of claim 8 wherein one of the gland and nut includes a snap ring and the other of the gland and nut includes a stop surface to engage the snap ring to capture the gland and the at least first collet within the nut.

11. The fitting subassembly of claim 8 wherein the gland and nut have cooperating threads to retain the gland and the at least first collet within the nut.

12. A fitting subassembly for connecting a conduit to a body, the fitting subassembly and the body combining a collet-seal with a conduit and a face seal, the body having a passage therethrough for carrying a fluid, the passage terminating at a generally flat first face transverse to the passage, the fitting subassembly comprising:
a gland having a passage therethrough for carrying a fluid and the passage terminating at a generally flat second face transverse to the passage, the second face being proportioned to be positioned in sealing engagement with the first face and with the passages through the gland in fluid communication with the passage through the body,
the gland having an internal passage for receiving an end portion of the conduit,
a collet assembly proportioned to surround the conduit and adapted to be squeezed into sealing engagement with the conduit,
a nut surrounding the gland and adapted to engage the body, to force the second face into sealing engagement with the first face, and to force the collet assembly into sealing engagement with the conduit and the internal passage in the gland, and wherein the collet assembly is captured by the gland and nut independent of the body.

13. The fitting subassembly of claim 12 wherein the nut is retractable along the conduit from an advanced position in which it engages the body to a retracted position in which the second face is free to slide transversely with respect to the first face, the collet assembly being captured by the gland and the nut when the nut is in the retracted position.

14. The fitting subassembly of claim 12 wherein the body includes threads and the nut includes threads adapted to cooperate with the threads on the body to force the first face and the second face into sealing engagement with each other and to force the collet assembly into sealing engagement with the conduit and with the internal passage in the gland.

15. The fitting subassembly of claim 14 wherein the threads on the body are external threads and the threads on the nut are internal threads.

16. The fitting subassembly of claim 12 wherein the collet assembly includes a single collet.

17. The fitting subassembly of claim 12 wherein the collet assembly includes a pair of collets.

18. The fitting subassembly of claim 13 wherein the nut and the gland include surfaces positioned to limit the distance the nut is retractable.

19. The fitting subassembly of claim 18 wherein the surfaces on the nut and the gland comprise a stop surfaces that engage each other to limit the distance the nut is retractable.

20. The fitting subassembly of claim 19 wherein the passage through the body and the passage through the gland define an axis, the gland and the nut each having an annular ridge, each ridge having a conical surface centered about the axis and one of the stop surfaces, the stop surfaces being more nearly normal to the axis than the conical surfaces, and the stop surfaces being in contact with each other when the nut is at one axial limit of its movement.

21. The fitting subassembly of claim 20 wherein the conical surfaces of the annular ridges of the gland and nut engage each other and cause the gland and nut to elastically deform as the nut moves axially of the gland.

22. The fitting subassembly of claim 21 wherein the nut and gland retain the collet assembly within a cavity defined by the nut and gland prior to receipt of an end portion of the conduit in the internal passage of the gland.

23. The fitting subassembly of claim 12 wherein the second face includes an annular recess to receive a resilient O-ring.

24. A fitting subassembly adapted to be made up to form a seal with a conduit inserted into the subassembly and to cooperate with an axially extending body having a generally flat rear end face transverse to the axis of the body by releasably engaging the body, the fitting subassembly comprising:
a gland having a central axis and a generally flat forward end face transverse to the axis of the gland and proportioned to seat against the rear end face of the body,
at least a first collet to seal between the conduit and the gland when the subassembly is made up, and
a nut having an opening in a rear end face to receive a conduit, the nut having a forward end face and being proportioned to surround the first collet and the gland, the nut being movable forward and rearward between advanced and retracted positions, respectively, the nut in the advanced position engaging the body and transmitting an axially compressive force to the first collet and pressing the forward end face of the gland against the rear end face of the body, and the nut in the retracted position having its forward end face no farther forward than the plane of the forward end face of the gland, and
one of the gland and the nut having a resilient O-ring and the other of the gland and the nut having a ridge, the O-ring and the ridge limiting axial movement of the nut with respect to the gland in a rearward direction to maintain the at least first collet in coaxial alignment with the axis of the gland before the subassembly is made up.

25. The fitting subassembly of claim 24 including a second O-ring positioned to cooperate with the ridge to limit rearward movement of the nut after it reaches the retracted position.

26. The subassembly of claim 24 wherein the nut includes an interior annular recess and the O-ring is received in the recess.

27. The subassembly of claim 24 wherein the ridge includes oppositely facing conical surfaces that engage the O-ring as the nut moves between the advanced and retracted positions.

28. The subassembly of claim 27 wherein the ridge extends radially outward from the gland and the O-ring is received in a recess in the nut.

29. The fitting subassembly of claim 1 wherein the forward end face of the gland includes an annular recess.

30. A fitting assembly comprising the fitting subassembly of claim 24 and an axially extending body having a generally flat rear end face transverse to the axis of the body, the rear end face of the body having an annular recess and an O-ring in the recess.
